(19) United States
(12) Patent Application Publication
(10) Pub. No.: US 2001/0036982 A1
(43) Pub. Date: Nov. 1, 2001

(54) Flame retarded polymers

(75) Inventor: Peter Staniek, Binzen (DE)

Correspondence Address: CLARIANT CORPORATION, Industrial Property Department, 4331 Chesapeake Drive, Charlotte, NC, 28216, US

(73) Assignee: CLARIANT FINANCE (BVI) LIMITED

(21) Appl. No.: 09/836,304

(22) Filed: Apr. 17, 2001

(30) Foreign Application Priority Data
Apr. 17, 2000 (CH) 2000 0757/00

(51) Int. Cl. C08K 5/52; C08K 5/53

(52) U.S. Cl. 524/123; 524/127

(57) ABSTRACT

The present invention relates to the use of phosphorus compounds of the formula (I) or (II)

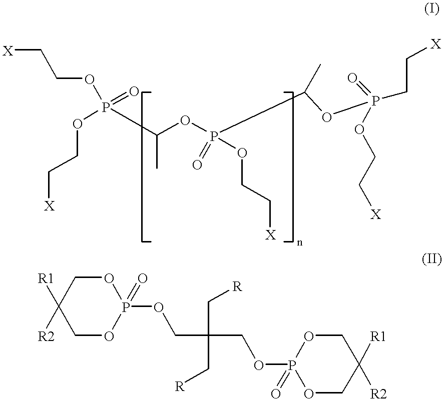

as flame retardants for fibers or films of polyacrylonitrile, its copolymers or polymer blends thereof. X and R are preferably chloro, R1 and R2 are preferably methyl, and n is preferably 0-5.

### BACKGROUND OF THE INVENTION

The invention relates to the use of certain phosphorus compounds as flame retardants for fibers or films of polyacrylonitrile or its copolymers.

Fibers or films of polyacrylonitrile or its copolymers are classified as flammable and hence in certain applications, such as in aircraft construction, for example, require a flame retardant treatment. Polymers are frequently rendered flame retardant by adding phosphorus or halogen compounds, or mixtures thereof, to them. Mixtures of phosphorus compounds and nitrogen compounds are also often used as flame retardants. However, there is an increasing demand for improved flame retardants.

### SUMMARY OF THE INVENTION

It has surprisingly now been found that the phosphorus compounds of the formulae (I) and (II) are outstanding flame retardants for fibers or films of polyacrylonitrile or its copolymers or polymer blends thereof.

### DESCRIPTION OF THE PREFERRED EMBODIMENTS

The invention accordingly provides for the use of phosphorus compounds of the formulae (I) or (II)

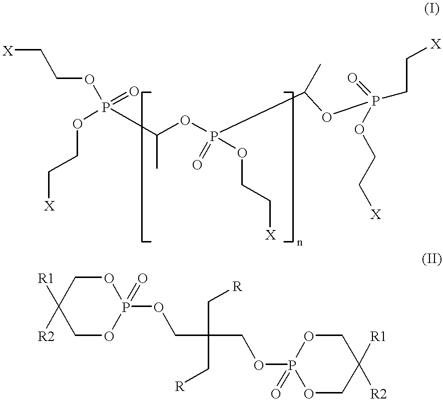

where

X is chloro or bromo, preferably chloro,

R₁ and R₂ independently of one another are hydrogen, C₁₋₁₈ alkyl, C₆₋₁₈ aryl, C₇₋₂₄ alkylaryl, preferably C₁₋₁₂ alkyl, phenyl, benzyl, especially C₁₋₆ alkyl, very preferably methyl, or R₁ and R₂ together form a cyclohexyl or cyclohexenyl radical, preferably a cyclohexyl radical, and

R is chloro, bromo or a group of the formula (III)

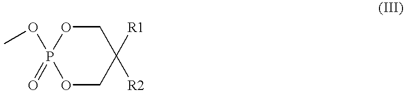

and

n is a number between 0 and 20, preferably between 0 and 10, in particular between 0 and 5,

as flame retardants for polyacrylonitrile, its copolymers or polymer blends thereof, especially for use in fibers or films of these materials.

Preference is given to compounds of the formula (I) or (II) where

X is chloro,

R is chloro or a group of the formula (III),

R₁ and R₂ are C₁₋₆ alkyl or together are a cyclohexyl radical, and

n is a number from 0 to 10.

Particular preference is given to compounds of the formula (I) or (II) where

X is chloro,

R is chloro,

R₁ and R₂ are methyl, and

n is a number from 0 to 5.

Flame retardancy is achieved at concentrations of 1-30% by weight, preferably at 5-20% by weight, and with particular preference 10-20% by weight, based on the overall mass of the polymer formulation.

The compounds of the formulae (I) and (II) are known as flame retardants for polymethyl methacrylate, for example from DE-A-3 838 480; however, it does not reveal their outstanding suitability for polyacrylonitrile or its copolymers.

The polymers to be stabilized are homopolymers of acrylonitrile (PAN), copolymers of this monomer, or polymer blends comprising this material. Likewise included are mixtures of polyacrylonitrile fibers with other fiber materials, such as cotton, viscose, wool, polyamide, polyester and the like, for example, which if desired may also have been treated with the same flame retardants of the invention or else with different flame retardants.

A non-limiting selection of such abovementioned polymers comprises:

Acrylonitrile-butadiene copolymers, acrylonitrile-butadiene-styrene copolymers, acrylonitrile-alkyl acrylate copolymers, acrylonitrile-alkoxyalkyl acrylate copolymers, acrylonitrile-vinyl halide copolymers or acrylonitrile-alkyl methacrylate-butadiene terpolymers, graft copolymers of styrene and acrylonitrile on polyalkyl acrylates or polyalkyl methacrylates, styrene and acrylonitrile on acrylate-butadiene copolymers, and also mixtures thereof, such as those known, for example, as ABS polymers.

The polymers described may be employed in any of the very wide variety of forms, such as, for example, as sheets, films, cast material, injection moldings, or fibers, including hollow fibers.

These polymers may comprise further additives such as, for example, antioxidants, light stabilizers (UV absorbers and/or HALS compounds), metal deactivators, peroxide-destroying compounds, polyamide stabilizers, basic costabilizers, nucleating agents, fillers, reinforcing agents, plasticizers, lubricants, emulsifiers, pigments and dyes, optical brighteners, flame retardants, antistats, blowing agents, etc.

Specifically, these may comprise the following compounds:

1. Antioxidants

1.1 Alkylated monophenols, e.g. 2,6-di-tert-butyl-4-methylphenol, 2-butyl-4,6-dimethylphenol, 2,6-di-tert-butyl-4-ethylphenol, 2,6-di-tert-butyl-4-n-butylphenol, 2,6-di-tert-butyl-4-isobutylphenol, 2,6-dicyclopentyl-4-methylphenol, 2-(α-methylcyclohexyl)-4,6-dimethylphenol, 2,6-di-octadecyl-4-methylphenol, 2,4,6-tricyclohexylphenol, 2,6-di-tert-butyl-4-methoxymethylphenol, linear or sidechain-branched nonylphenols, such as 2,6-dinonyl-4-methylphenol, 2,4-dimethyl-6-(1′-methylundec-1′-yl)phenol, 2,4-dimethyl-6-(1′-methylheptadec-1′-yl)phenol, 2,4-dimethyl-6-(1′-methyltridec-1′-yl)phenol and mixtures thereof.

1.2 Alkylthiomethylphenols, e.g. 2,4-dioctylthiomethyl-6-tert-butylphenol, 2,4-dioctylthiomethyl-6-methylphenol, 2,4-dioctylthiomethyl-6-ethylphenol, 2,6-didodecylthiomethyl-4-nonylphenol.

1.3 Hydroquinones and alkylated hydroquinones, e.g. 2,6-di-tert-butyl-4-methoxyphenol, 2,5-di-tert-butylhydroquinone, 2,5-di-tert-amylhydroquinone, 2,6-diphenyl-4-octadecyloxyphenol, 2,6-di-tert-butylhydroquinone, 2,5-di-tert-butyl-4-hydroxyanisole, 3,5-di-tert-butyl-4-hydroxyanisole, 3,5-di-tert-butyl-4-hydroxyphenyl stearate, bis(3,5-di-tert-butyl-4-hydroxyphenyl) adipate.

1.4 Hydroxylated thiodiphenyl ethers, e.g. 2,2′-thiobis(6-tert-butyl-4-methylphenol), 2,2′-thiobis(4-octylphenol), 4,4′-thiobis(6-tert-butyl-3-methylphenol), 4,4′-thio-bis(6-tert-butyl-2-methylphenol), 4,4′-thiobis(3,6-di-sec-amylphenol), 4,4′-bis(2,6-dimethyl-4-hydroxyphenyl) disulphide.

1.5 Alkylidenebisphenols, e.g. 2,2′-methylenebis(6-tert-butyl-4-methylphenol), 2,2′-methylenebis(6-tert-butyl-4-ethylphenol), 2,2′-methylenebis[4-methyl-6-(α-methylcyclohexyl)-phenol], 2,2′-methylenebis(4-methyl-6-cyclohexylphenol), 2,2′-methylenebis(6-nonyl-4-methylphenol), 2,2′-methylenebis(4,6-di-tert-butylphenol), 2,2′-ethylidenebis(4,6-di-tert-butylphenol), 2,2′-ethylidenebis-(6-tert-butyl-4-isobutylphenol), 2,2′-methylenebis[6-(α-methylbenzyl)-4-nonylphenol], 2,2′-methylenebis[6-(α,α-dimethylbenzyl)-4-nonylphenol], 4,4′-methylenebis(2,6-di-tert-butylphenol), 4,4′-methylenebis(6-tert-butyl-2-methylphenol), 1,1-bis(5-tert-butyl-4-hydroxy-2-methylphenyl)butane, 2,6-bis(3-tert-butyl-5-methyl-2-hydroxybenzyl)-4-methylphenol, 1,1,3-tris(5-tert-butyl-4-hydroxy-2-methylphenyl)butane, 1,1-bis(5-tert-butyl-4-hydroxy-2-methylphenyl)-3-n-dodecylmercaptobutane, bis(3-tert-butyl-4-hydroxy-5-methylphenyl)-dicyclopentadiene, bis[2-(3′-tert-butyl-2′-hydroxy-5′-methylbenzyl)-6-tert-butyl-4-methylphenyl] terephthalate, 1,1-bis(3,5-dimethyl-2-hydroxyphenyl)butane, 2,2-bis(3,5-di-tert-butyl-4-hydroxyphenyl)propane, 2,2-bis(5-tert-butyl-4-hydroxy-2-methylphenyl)-4-n-dodecylmercaptobutane, 1,1,5,5-tetra(5-tert-butyl-4-hydroxy-2-methylphenyl)-pentane, ethylene glycol bis[3,3-bis(3′-tert-butyl-4′-hydroxyphenyl)butyrate].

1.6 O-, N- and S-benzyl compounds, e.g. 3,5,3′,5′-tetra-tert-butyl-4,4′-dihydroxydibenzyl ether, octadecyl 4-hydroxy-3,5-dimethylbenzylmercaptoacetate, tris(3,5-di-tert-butyl-4-hydroxybenzyl)amine, bis(4-tert-butyl-3-hydroxy-2,6-dimethyl-benzyl) dithioterephthalate, bis(3,5-di-tert-butyl-3-hydroxybenzyl) sulphide, iso-octyl 3,5-di-tert-butyl-4-hydroxybenzylmercaptoacetate, tridecyl 4-hydroxy-3,5-di-tert-butylbenzylmercaptoacetate.

1.7 Hydroxybenzylated malonates, e.g. dioctadecyl 2,2-bis(3,5-di-tert-butyl-2-hydroxybenzyl)malonate, dioctadecyl 2-(3-tert-butyl-4-hydroxy-5-methylbenzyl)-malonate, didodecyl mercaptoethyl-2,2-bis(3,5-di-tert-butyl-4-hydroxybenzyl)-malonate, di[4(1,1,3,3-tetramethylbutyl)phenyl] 2,2-bis(3,5-di-tert-butyl-4-hydroxybenzyl)malonate.

1.8 Hydroxybenzylaromatics, e.g. 1,3,5-tris(3,5-di-tert-butyl-4-hydroxybenzyl)-2,4,6-trimethylbenzene, 1,4-bis(3,5-di-tert-butyl-4-hydroxybenzyl)-2,3,5,6-tetramethylbenzene, 2,4,6-tris(3,5-di-tert-butyl-4-hydroxybenzyl)phenol.

1.9 Triazine compounds e.g. 2,4-bisoctylmercapto-6-(3,5-di-tert-butyl-4-hydroxyanilino)-1,3,5-triazine, 2-octylmercapto-4,6-bis(3,5-di-tert-butyl-4-hydroxyanilino)-1,3,5-triazine, 2-octylmercapto-4,6-bis(3,5-di-tert-butyl-4-hydroxyphenoxy)-1,3,5-triazine, 2,4,6-tris(3,5-di-tert-butyl-4-hydroxyphenoxy)-1,2,3-triazine, 1,3,5-tris-(3,5-tert-butyl-4-hydroxybenzyl) isocyanurate, 1,3,5-tris(4-tert-butyl-3-hydroxy-2,6-dimethylbenzyl) isocyanurate, 2,4,6-tris(3,5-di-tert-butyl-4-hydroxyphenyl-ethyl)-1,3,5-triazine, 1,3,5-tris(3,5-di-tert-butyl-4-hydroxyphenylpropionyl)hexa-hydro-1,3,5-triazine, 1,3,5-tris(3,5-dicyclohexyl-4-hydoxybenzyl) isocyanurate.

1.10 Benzylphosphonates, e.g. dimethyl 2,5-di-tert-butyl-4-hydroxybenzylphosphonate, diethyl 3,5-di-tert-butyl-4-hydroxybenzylphosphonate, dioctadecyl 3,5-di-tert-butyl-4-hydroxybenzylphosphonate, dioctadecyl 5-tert-butyl-4-hydroxy-3-methylbenzylphosphonate, Ca salt of 3,5-di-tert-butyl-4-hydroxybenzylphosphonic acid monoethyl ester.

1.11 Acylaminophenols, e.g. 4-hydroxylauranilide, 4-hydroxystearanilide, octyl N-(3,5-di-tert-butyl-4-hydroxyphenyl)carbamate.

1.12 Esters of β-(3,5-di-tert-butyl-4-hydroxyphenyl)propionic acid with monohydric or polyhydric alcohols, such as with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.13 Esters of β-(5-tert-butyl-4-hydroxy-3-methylphenyl)propionic acid with monohydric or polyhydric alcohols, such as, for example, with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.14 Esters of β-(3,5-dicyclohexyl-4-hydroxyphenyl)propionic acid with monohydric or polyhydric alcohols, such as, for example, with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.15 Esters of 3,5-di-tert-butyl-4-hydroxyphenylacetic acid with monohydric or polyhydric alcohols, such as, for example, with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.16 Esters of 3,3-bis(3′-tert-butyl-4′-hydroxyphenyl)butyric acid with monohydric or polyhydric alcohols, such as, for example, with methanol, ethanol, n-octanol, i-octanol, octadecanol, 1,6-hexanediol, 1,9-nonanediol, ethylene glycol, 1,2-propanediol, neopentyl glycol, thiodiethylene glycol, diethylene glycol, triethylene glycol, pentaerythritol, tris(hydroxyethyl) isocyanurate, N,N′-bis(hydroxyethyl)oxalamide, 3-thiaundecanol, 3-thiapentadecanol, trimethylhexanediol, trimethylolpropane, 4-hydroxymethyl-1-phospha-2,6,7-trioxabicyclo[2.2.2]octane.

1.17 Amides of β-(3,5-di-tert-butyl-4-hydroxyphenyl)propionic acid, such as, for example, N,N′-bis(3,5-di-tert-butyl-4-hydroxyphenylpropionyl)hexamethylenediamine, N,N′-bis(3,5-di-tert-butyl-4-hydroxyphenylpropionyl)trimethylenediamine, N,N′-bis(3,5-di-tert-butyl-4-hydroxyphenylpropionyl)hydrazine.

1.18 Tocopherol, such as, for example, α-tocopherol, β-tocopherol, γ-tocopherol, δ-tocopherol and mixtures thereof (vitamin E).

1.19 Ascorbic acid (vitamin C).

1.20 Amine antioxidants, such as, for example, N,N′-diisopropyl-p-phenylenediamine, N,N′-di-sec-butyl-p-phenylenediamine, N,N′-bis(1,4-dimethylpentyl)-p-phenylenediamine, N,N′-bis(1-ethyl-3-methylpenyl)-p-phenylenediamine, N,N′-bis(1-methylheptyl)-p-phenylenediamine, N,N′-dicyclohexyl-p-phenylenediamine, N,N′-di-phenyl-p-phenylenediamine, N,N′-di(naphth-2-yl)-p-phenylenediamine, N-isopropyl, N′-phenyl-p-phenylenediamine, N-(1,3-dimethylbutyl)-N′-phenyl-p-phenylenediamine, N-(1-methylheptyl)-N′-phenyl-p-phenylenediamine, N-cyclohexyl-N′-phenyl-p-phenylenediamine, 4-(p-toluenesulphonamido)diphenylamine, N,N′-dimethyl-N,N′-di-sec-butyl-p-phenylenediamine, diphenylamine, N-allyldiphenylamine, 4-isopropoxydiphenylamine, N-phenyl-1-naphthylamine, N-(4-tert-octylphenyl)-1-naphthylamine, N-phenyl-2-naphthylamine, octylated diphenylamine, e.g. p,p′-di-tert-octyldiphenylamine, 4-n-butylaminophenol, 4-butyrylaminophenol, 4-nonanoylaminophenol, 4-dodecanoylaminophenol, 4-octadecanoylaminophenol, di(4-methoxyphenyl)amine, 2,6-di-tert-butyl-4-dimethylaminomethylphenol, 2,4′-diaminodiphenylmethane, 4,4′-diaminodiphenylmethane, N,N, N′N′-tetramethyl-4,4′-diaminodiphenylmethane, 1,2-di[(2-methylphenyl)amino]ethane, 1,2-di(phenylamino)propane, o-tolyl biguanide, di[4-(1′,3′-dimethylbutyl)phenyl]amine, tert-octylated N-phenyl-1-naphthylamine, mixture of monoalkylated and dialkylated tert-butyl-/tert-octyldiphenylamines, mixture of monoalkylated and dialkylated nonyldiphenylamines, mixture of monoalkylated and dialkylated dodecyldiphenylamines, mixture of monoalkylated and dialkylated isopropyl-/isohexyldiphenylamines, mixture of monoalkylated and dialkylated tert-butyldiphenylamines, 2,3-dihydro-3,3-dimethyl-4H-1,4-benzothiazine, phenothiazine, mixture of monoalkylated and dialkylated tert-butyl-/tert-octylphenothiazines, mixture of monoalkylated and dialkylated tert-octylphenothiazines, N-allylphenothiazine, N,N,N′-N′-tetraphenyl-1,4-diaminobut-2-ene, N,N-bis(2,2,6,6-tetramethylpiperid-4-yl)-hexamethylenediamine, bis(2,2,6,6-tetramethylpiperid-4-yl) sebacate, 2,2,6,6-tetramethylpiperidin-4-one, 2,2,6,6-tetramethylpiperidin-4-ol.

2. UV Absorbers and Light Stabilizers

2.1 2-(2′-hydroxyphenyl)benzotriazolees, such as, for example, 2-(2′-hydroxy-5′-methylphenyl)benzotriazole, 2-(3′,5′-di-tert-butyl-2′-hydroxyphenyl)benzotriazole, 2-(5′-tert-butyl-2′-hydroxyphenyl)benzotriazole, 2-[2′-hydroxy-5′-(1,1,3,3-tetramethylbutyl)phenyl]benzotriazolee, 2-(3′,5′-di-tert-butyl-2′-hydroxyphenyl)-5-chlorobenzotriazole, 2-(3′-tert-butyl-2′-hydroxy-5′-methylphenyl)-5-chlorobenzotriazole, 2-(3′-sec-butyl-5′-tert-butyl-2′-hydroxyphenyl)benzotriazole, 2-(2′-hydroxy-4′-octoxyphenyl)benzotriazole, 2-(3′,5′-di-tert-amyl-2′-hydroxyphenyl)benzotriazole, 2-(3′,5′-bis(α,α-dimethylbenzyl)-2′-hydroxyphenyl)benzotriazole, mixture of 2-(3′-tert-butyl-2′-hydroxy-5′-(2-octyloxycarbonylethyl)phenyl-5-chlorobenzotriazole, 2-(3′-tert-butyl-5′[2-(2-ethylhexyloxy)carbonylethyl]-2′-hydroxyphenyl)-5-chlorobenzotriazole, 2-(3′-tert-butyl-2′-hydroxy-5′-(2-methoxycarbonylethyl)phenyl)-5-chlorobenzotriazole, 2-(3′-tert-butyl-2′-hydroxy-5′-(2-methoxycarbonylethyl)phenyl)benzotriazole, 2-(3′-tert-butyl-2′-hydroxy-5′-(2-octyloxycarbonylethyl)phenyl)benzotriazole, 2-(3′-tert-butyl-5′-[2-(2-ethylhexyloxy)carbonylethyl]-2′-hydroxyphenyl)benzotriazole, 2-(3′-dodecyl-2′-hydroxy-5′-methylphenyl)benzotriazole, and 2-(3′-tert-butyl-2′-hydroxy-5′-(2-isooctyloxycarbonylethyl)phenylbenzotriazole, 2,2′-methylenebis[4-(1,1,3,3-tetramethylbutyl)-6-benzotriazole-2-ylphenol]; transesterification product of 2-[3′-tert-butyl-5′-(2-methoxycarbonylethyl)-2′-hydroxyphenyl]benzotriazole with polyethylene glycol 300; [R—CH₂CH₂—COO(CH₂)₃]₂ where R is 3′-tert-butyl-4′-hydroxy-5′-2H-benzotriazole-2-ylphenyl.

2.2 2-hydroxybenzophenones, such as, for example, the 4-hydroxy, 4-methoxy, 4-octoxy, 4-decyloxy, 4-dodecyloxy, 4-benzyloxy, 4,2′,4′-trihydroxy, 2′-hydroxy-4,4′-dimethoxy derivatives.

2.3 Esters of unsubstituted or substituted benzoic acids, such as, for example, 4-tert-butylphenyl salicylate, phenyl salicylate, octylphenyl salicylate, dibenzoylresorcinol, bis(4-tert-butylbenzoyl)resorcinol, benzoylresorcinol, 2,4-di-tert-butylphenyl 3,5-di-tert-butyl-4-hydroxybenzoate, hexadecyl 3,5-di-tert-butyl-4-hydroxybenzoate, octadecyl 3,5-di-tert-butyl-4-hydroxybenzoate, 2-methyl-4,6-di-tert-butylphenyl 3,5-di-tert-butyl-4-hydroxybenzoate.

2.4 Acrylates such as, for example, ethyl and isooctyl α-cyano-β,β-diphenylacrylate, methyl α-carbomethoxycinnamate, methyl and butyl α-cyano-β-methyl-p-methoxycinnamate, methyl α-carbomethoxy-p-methoxycinnamate, N-(β-carbomethoxy-β-cyanovinyl)-2-methylindoline.

2.5 Nickel compounds such as, for example, nickel complexes of 2,2′-thiobis[1,1,3,3-tetramethylbutyl)phenol] such as the 1:1 and the 1:2 complex, with or without additional ligands, such as n-butylamine, triethanolamine or N-cyclohexyldiethanolamine, nickel dibutyldithiocarbamate, nickel salts of 4-hydroxy-3,5-di-tert-butylbenzylphosphonic acid monoalkyl esters, such as of the methyl or ethyl ester, nickel complexes of ketoximes, such as of 2-hydroxy-4-methylphenyl undecyl ketoxime, nickel complexes of 1-phenyl-4-lauroyl-5-hydroxypyrazole, with or without additional ligands.

2.6 Sterically hindered amines, such as, for example, bis(2,2,6,6-tetramethylpiperid-4-yl) sebacate, bis(2,2,6,6-tetramethylpiperid-4-yl) glutarate, bis(2,2,6,6-tetramethylpiperid-4-yl) succinate, bis(1,2,2,6,6-pentamethylpiperid-4-yl) sebacate, bis(1,2,2,6,6-pentamethylpiperid-4-yl) glutarate, bis(1,2,2,6,6-pentamethylpiperidyl) n-butyl-3,5-di-tert-butyl-4-hydroxybenzylmalonate, 2,2,6,6-tetramethylpiperidyl behenate, 1,2,2,6,6-tetramethylpiperidyl behenate, condensation product of 1-hydroxyethyl-2,2,6,6-tetramethyl-4-hydroxypiperidine and succinic acid, condensation products of N,N′-bis(2,2,6,6-tetramethyl-4-piperidyl)hexamethylenediamine and 4-tert-octylamino-2,6-dichloro-1,3,5-s-triazine, tris-(2,2,6,6-tetramethyl4-piperidyl) nitrilotriacetate, tetrakis(2,2,6,6-tetramethyl-4-piperidyl) 1,2,3,4-butanetetraoate, 1,1′-(1,2-ethanediyl)bis(3,3,5,5-tetramethylpiperazinone), 4-benzoyl-2,2,6,6-tetramethylpiperidine, 4-stearyloxy-2,2,6,6-tetramethylpiperidine, 4-stearoyloxy-2,2,6,6-tetramethylpiperidine, 4-stearyloxy-1,2,2,6,6-pentamethylpiperidine, 4-stearoyloxy-1,2,2,6,6-pentamethylpiperidine, bis(1,2,2,6,6-pentamethylpiperidyl) 2-n-butyl-2-(2-hydroxy-3,5-di-tert-butylbenzyl)malonate, bis(1,2,2,6,6-pentamethylpiperidyl)-2-n-butyl-2-(4-hydroxy-3,5-di-tert-butylbenzyl)malonate, 3-n-octyl-7,7,9,9-tetramethyl-1,3,8-triazaspiro[4.5]-decane-2,4-dione, bis(1-octyloxy-2,2,6,6-tetramethylpiperidyl) sebacate, bis(1-octyloxy-2,2,6,6-tetramethylpiperidyl) succinate, condensation product of N,N′-bis(2,2,6,6-tetramethyl-4-piperidyl)hexamethylenediamine and 4-morpholino-2,6-dichloro-1,3,5-triazine, condensation product of N,N′-bis(2,2,6,6-tetramethyl-4-piperidyl)hexamethylenediamine and 4-cyclohexylamino-2,6-dichloro-1,3,5-triazine, condensation product of 2-chloro-4,6-di(4-n-butylamino-2,2,6,6-tetramethylpiperidyl)-1,3,5-triazine and 1,2-bis(3-aminopropylamino)ethane, condensation product of 2-chloro-4,6-di(4-methoxypropylamino-2,2,6,6-tetramethylpiperidyl)-1,3,5-triazine and 1,2-bis(3-aminpropylamino)ethane, condensation product of 2-chloro-4,6-di(4-methoxypropylamino-1,2,2,6,6-pentamethylpiperidyl)-1,3,5-triazine and 1,2-bis(3-aminopropylamino)ethane, condensation product of 2-chloro-4,6-di(4-n-butylamino-1,2,2,6,6-pentamethylpiperidyl)-1,3,5-triazine and 1,2-bis(3-aminopropylamino)ethane, reaction products of 2-chloro-4,6-di-(4-n-butylamino-2,2,6,6-tetramethylpiperidyl)-1,3,5-triazine with monofunctional or polyfunctional amines with replacement of between one and all active H atoms on the amine, such as with ethylenediamine, diethylenetriamine, triethylenetetramine, hexamethylenediamine, 1,2-bis(3-aminopropylamino)ethane, reaction products of 2-chloro-4,6-di(4-n-butylamino-1,2,2,6,6-pentamethylpiperidyl)-1,3,5-triazine with monofunctional or poly-functional amines with replacement of between one and all active H atoms on the amine, such as with ethylenediamine, diethylenetriamine, triethylenetetr-amine, hexamethylenediamine, 1,2-bis(3-aminopropylamino)ethane, reaction products of 2-chloro-4,6-di(4-n-butylamino-2,2,6,6-tetramethylpiperidyl)-1,3,5-triazine and 4-tert-octylamino-2,6-dichloro-1,3,5-s-triazine with monofunctional or polyfunctional amines with replacement of between one and all active H atoms on the amine, such as with ethylenediamine, diethylenetriamine, triethylenetetr-amine, hexamethylenediamine, 1,2-bis(3-aminopropylamino)ethane, reaction products of 2-chloro-4,6-di(4-n-butylamino-1,2,2,6,6-pentamethylpiperidyl)-1,3,5-triazine and 4-tert-octylamino-2,6-dichloro-1,3,5-s-triazine with monofunctional or polyfunctional amines with replacement of between one and all active H atoms on the amine, such as with ethylenediamine, diethylenetriamine, triethylenetetramine, hexamethylenediamine, 1,2-bis(3-aminopropylamino)ethane, reaction products of 2-chloro-4,6-di(4-n-butylamino-2,2,6,6-tetramethylpiperidyl)-1,3,5-triazine and 4-(4-n-butylamino-2,2,6,6-tetramethylpiperidyl)-2,6-dichloro-1,3,5-s-triazine with monofunctional or polyfunctional amines with replacement of between one and all active H atoms on the amine, such as with ethylenediamine, diethylenetriamine, triethylenetetramine, hexamethylenediamine, 1,2-bis(3-aminopropylamino)ethane, reaction products of 2-chloro-4,6-di(4-n-butylamino-1,2,2,6,6-pentamethylpiperidyl)-1,3,5-triazine and 4-(4-n-butylamino-2,2,6,6-tetramethylpiperidyl)-2,6-dichloro-1,3,5-s-triazine with monofunctional or poly-functional amines with replacement of between one and all active H atoms on the amine, such as with ethylenediamine, diethylenetriamine, triethylenetetr-amine, hexamethylenediamine, 1,2-bis(3-aminopropylamino)ethane, condensation product of 1,2-bis(3-aminopropylamino)ethane and 2,4,6-trichloro-1,3,5-triazine and also 4-butylamino-2,2,6,6-tetramethylpiperidine, N-(2,2,6,6-tetramethyl-4-piperidyl)-n-dodecylsuccinimide, N-(1,2,2,6,6,-pentamethyl-4-piperidyl)-n-dodecylsuccinimide, 8-acetyl-3-dodecyl-7,7,9,9-tetramethyl-1,3,8-triazaspiro[4.5]decane-2,4-dione, oligomerized 2,2,4,4-tetramethyl-20-(oziranylmethyl)-7-oxa-3,20-diazadispiro[5.1.11.2]heneicosan-21-one, oligomerized 1,2,2,4,4-pentamethyl-20-(oxiranylmethyl)-7-oxa-3,20-diazadispiro[5.1.11.2]-heneicosan-21-one, oligomerized 1-acetyl-2,2,4,4-tetramethyl-20-(oxiranylmethyl)-7-oxa-3,20-diazadispiro[5.1.11.2]heneicosan-21-one, 3-dodecyl-1-(2,2,6,6-tetramethyl-4-piperidyl)pyrrolidine-2,5-dione, 3-dodecyl-1-(1,2,2,6,6-pentamethyl-4-piperidyl)pyrrolidine-2,5-dione, 2,2,4,4-tetramethyl-7-oxa-3,20-diazadispiro[5.1.11.2]heneicosan-21-one, dodecyl 2,2,4,4-tetramethyl-7-oxa-21-oxo-3,20-diazadispiro[5.1.11.2]heneicosane-3-propanoate, tetradecyl 2,2,4,4-tetramethyl-7-oxa-21-oxo-3,20-diazadispiro[5.1.11.2]heneicosane-3-propanoate, 2,2,3,4,4-pentamethyl-7-oxa-3,20-diazadispiro[5.1.11.2]heneicosan-2-one, dodecyl 2,2,3,4,4-pentamethyl-7-oxa-21-oxo-3,20-diazadispiro[5.1.11.2]heneicosane-3-propaneoate, tetradecyl 2,2,3,4,4-pentamethyl-7-oxa-21-oxo-3,20-diazadispiro[5.1.11.2]heneicosane-3-propanoate, 3-acetyl-2,2,4,4-tetramethyl-7-oxa-3,20-diazadispiro[5.1.11.2]heneicosan-21-one, dodecyl 3-acetyl-2,2,4,4-tetramethyl-7-oxa-21-oxo-3,20-diazadispiro[5.1.11.2]heneicosane-3-propanoate, tetradecyl 3-acetyl-2,2,4,4-tetramethyl-7-oxa-3,20-diaxadispiro[5.1.11.2]heneicosane-21-one, dodecyl 3-acetyl-2,2,4,4-tetramethyl-7-oxa-21-oxo-3,20-diazadispiro[5.1.11.2]heneicosane-3-propanoate, tetradecyl 3-acetyl-2,2,4,4-tetramethyl-7-oxa-21-oxo-3,20-diazadispiro[5.1.11.2]heneicosane-3-proponoate, 1,1′,3,3′,5,5′-hexahydro-2,2′,4,4′,6,6′-hexaaza-2,2′,6,6′-bismethano-7,8-dioxo-4,4′-bis(1,2,2,6,6-pentamethyl-4-piperidyl)biphenyl, poly-N,N′-bis(2,2,6,6-tetra-methyl-4-piperidyl)-1,8-diazadecylene, addition compound of 2,2,6,6-tetramethyl-4-allyloxypiperidine and polymethylhydrosiloxane (molar mass up to 4000), addition compound of 1,2,2,6,6-pentamethyl-4-allyloxypiperidine and polymethylhydrosiloxane (molar mass up to 4000), N,N′-diformyl-N,N′-bis(2,2,6,6-tetramethyl-4-piperidyl)hexamethylenediamine, N,N′-diformyl-N,N′-bis(1,2,2,6,6-pentamethyl-4-piperidinyl)hexamethylenediamine, 5,11-bis(2,2,6,6-tetramethyl-4-piperidyl)-3,5,7,9,11,13-hexaazatetracyclo[7.4.0.0^{2,7}.1^{3,13}]tetradecane-8,14-dione, 5,11-bis(1,2,2,6,6-pentamethyl-4-piperidyl)-3,5,7,9,11,13-hexaazatetracyclo-[7.4.0.0^{2,7}.1^{3,13}]tetradecane-8,14-dione, bis(2,2,6,6-tetramethyl-4-piperidyl) [(4-methoxyphenyl)methylene]propanedioate, bis(1,2,2,6,6-pentamethyl-4-piperidyl) [(4-methoxyphenyl)methylene]propanedioate, 2,4,6-tris(N-cyclohexyl-N-[2-(3,3,4,5,5-pentamethylpiperazinon-1-yl)ethyl]amino-1,3,5-triazine, copolymer of styrene with methylstyrene and maleic anhydride reacted with 4-amino-2,2,6,6-tetramethylpiperidine and octadecylamine, copolymer of styrene with α-methylstyrene and maleic anhydride reacted with 4-amino-1,2,2,6,6-pentamethylpiperidine and octadecylamine, polycarbonate with 2,2′-[(2,2,6,6-tetramethyl-4-piperidyl)imino]bis[ethanol] as diol component, polycarbonate of 2,2′-(1,2,2,6,6-pentamethyl-4-piperidyl)imino]bis[ethanol] as diol component, copolymer of maleic anhydride and an α-olefin up to C₃₀ reacted with 4-amino-2,2,6,6-tetramethylpiperidine, copolymer of maleic anhydride and an α-olefin up to C₃₀ reacted with 1-acetyl-4-amino-2,2,6,6-tetramethylpiperidine, copolymer of maleic anhydride and an α-olefin up to C₃₀ reacted with 4-amino-1,2,2,6,6-pentamethylpiperidine, and also the N-alkyl- and N-aryloxy derivatives of the abovementioned compounds with free NH groups on the piperidine, especially α-methylbenzyloxy- and alkyloxy- of C₁ to C₁₈.

2.7 Oxalamides, such as, for example, 4,4′-dioctyloxyoxanilide, 2,2′-diethoxyoxanilide, 2,2′-dioctyloxy-5,5′-di-tert-butyloxanilide, 2,2′-didodecyloxy-5,5′-di-tert-butyloxanilide, 2-ethoxy-2′-ethyloxanilide, N,N′-bis(3-dimethylaminopropyl)oxalamide, 2-ethoxy-5-tert-butyl-2′-ethyloxanilide and its mixture with 2-ethoxy-2′-ethyl-5,4′-di-tert-butyloxanilide, mixtures of o- and p-methoxy- and also of o- and p-ethoxy-disubstituted oxanilides.

2.8 2-(2-hydroxyphenyl)-1,3,5-triazines, such as, for example, 2,4,6-tris(2-hydroxy-4-octyloxyphenyl)-1,3,5-triazine, 2-(2-hydroxy-4-octyloxyphenyl)-4′,6-bis(2′-4-di-methylphenyl)-1,3,5-triazine, 2-(2,4-dihydroxyphenyl)-4,6-bis(2,4-dimethylphenyl)-1,3,5-triazine, 2-(2,4-dihydroxyphenyl)-4,6-bis(2,4-dimethylphenyl)-1,3,5-triazine, 2,4-bis(2-hydroxy-4-propyloxyphenyl)-6-(2,4-dimethylphenyl)-1,3,5-triazine, 2-(2-hydroxy-4-octyloxyphenyl)-4,6-bis(4-methylphenyl)-1,3,5-triazine, 2-(2-hydroxy-4-dodecyloxyphenyl)-4,6-bis(2,4-dimethylphenyl-1,3,5-triazine, 2-[2-hydroxy-4-(2-hydroxy-3-butyloxypropyloxy)phenyl]-4,6-bis(2,4-dimethylphenyl)-1,3,5-triazine, 2-[2-hydroxy-4(2-hydroxy-3-octyloxypropyloxy)phenyl]-4,6-bis(2,4-dimethyphenyl)-1,3,5-triazine, 2-(2-hydroxy-4-tridecyloxyphenyl)-4,6-bis(2,4-dimethylphenyl)-1,3,5-triazine, 2-[4-dodecyloxy/tridecyloxy-2-hydroxypropoxy)-2-hydroxyphenyl]-4,6-bis(2,4-dimethylphenyl)-1,3,5-triazine, 2-[2-hydroxy-4-(2-hydroxy-3-dodecyloxypropoxy)phenyl]-4,6-bis(2,4-dimethylphenyl)-1,3,5-triazine, 2-(2-hydroxy-4-hexyloxy)phenyl-4,6-diphenyl-1,3,5-triazine, 2-(2-hydroxy-4-methoxyphenyl)-4,6-diphenyl-1,3,5-triazine, 2,4,6-tris[2-hydroxy-4-(3-butoxy-2-hydroxypropoxy)phenyl]-1,3,5-triazine, 2-(2-hydroxyphenyl)-4-(4-methoxyphenyl)-6-phenyl-1,3,5-triazine.

3. Metal deactivators, such as, for example, N,N′-diphenyloxalamide, N-salicylal-N′-salicyloylhydrazine, N,N′-bis(salicyloyl)hydrazine, N,N′-bis(3,5-di-tert-butyl-4-hydroxyphenylpropionyl)hydrazine, 3-salicyloylamino-1,2,4-triazolee, bis(benzylidene)oxalic dihydrazide, oxanilide, isophthalic dihydrazide, sebacic bisphenylhydrazide, N,N′-diacetyladipic dihydrazide, N,N′-bissalicyloyloxalic dihydrazide, N,N′-bissalicyloylthiopropionic dihydrazide.

4. Phosphites and phosphonites, such as, for example, triphenyl phosphite, diphenyl alkyl phosphites, phenyl dialkyl phosphites, tris(nonylphenyl) phosphite, trilauryl phosphite, trioctadecyl phosphite, distearyl pentaerythrityl diphosphite, tris(2,4-di-tert-butylphenyl) phosphite, diisodecyl pentaerythritol diphosphite, bis(2,4-di-tert-butylphenyl) pentaerythrityl diphosphite, bis(2,6-di-tert-butyl-4-methylphenyl) pentaerythrityl diphosphite, bisisodecyloxy pentaerythrityl diphosphite, bis(2,4-di-tert-butyl-6-methylphenyl) pentaerythrityl diphosphite, bis(2,4,6-tri-tert-butylphenyl) pentaerythrityl diphosphite, tristearyl sorbityl triphosphite, tetrakis(2,4-di-tert-butylphenyl) 4,4′-biphenylene diphosphonite, 6-isooctyloxy-2,4,8,10-tetra-tert-butyl-12H-dibenzo[d,g]-1,3,2-dioxaphosphocin, 6-fluoro-2,4,8,10-tetra-tert-butyl-12-methyldibenzo[d,g]-1,3,2-dioxaphosphocine, bis(2,4-di-tert-butyl-6-methylphenyl) methyl phosphite, bis(2,4-di-tert-butyl-6-methylphenyl) ethyl phosphite, tris(2-tert-butyl-4-thio(2′-methyl-4′-hydroxy-5′-tert-butyl)phenyl-5-methyl) phenyl phosphite, 2,2′,2″-nitrilo[triethyl tris(3,3′,5,5′-tetra-tert-butyl-1,1′-biphenyl-2,2′-diyl) phosphite], ethyl bis[2-methyl-4,6-bis(1,1-dimethylethyl)phenol]phosphite.

5. Hydroxylamines, such as, for example, N,N-dibenzylhydroxylamine, N,N-diethylhydroxylamine, N,N-dioctylhydroxylamine, N,N-dilaurylhydroxylamine, N,N-ditetradecylhydroxylamine, N,N-dihexadecylhydroxylamine, N,N-dioctadecylhydroxylamine, N-hexadecyl-N-octadecylhydroxylamine, N-heptadecyl-N-octa-decylhydroxylamine, N,N-dialkylhydroxylamines prepared from hydrogenated tallow fatty amine.

6. Nitrones, such as, for example, N-benzyl-alpha-phenylnitrone, N-ethyl-alphamethylnitrone, N-octyl-alpha-heptylnitrone, N-lauryl-alpha-undecylnitrone, N-tetradecyl-alpha-tridecylnitrone, N-hexadecyl-alpha-pentadecylnitrone, N-octadecyl-alpha-heptadecylnitrone, N-hexadecyl-alpha-heptadecylnitrone, N-octadecyl-alpha-pentadecylnitrone, N-heptadecyl-alpha-heptadecylnitrone, N-octadecyl-alpha-hexadecyinitrone, nitrones derived from N,N-dialkylhydroxylamines prepared from hydrated tallow fatty amines.

7. Zeolites and hydrotalcites, such as ⁷DHT 4A, for example. Such hydrotalcites may be described by the general formula

[(M²⁺)₁₋ₓ(M³⁺)ₓ(OH)₂(Aⁿ⁻)_{x/n}yH₂O]

where

(M²⁺) is Mg, Ca, Sr, Ba, Zn, Pb, Sn or Ni

(M³⁺) is Al, B or Bi

Aⁿ is an anion of valency n

n is an integer 1-4

x is a value between 0 and 0.5

y is a value between 0 and 2

A is OH⁻, Cl⁻, Br⁻, I⁻, ClO₄⁻, CH₃COO⁻, C₆H₅COO⁻, CO₃²⁻, SO₄²⁻, (OOC—COO)²⁻, (CHOHCOO)₂²⁻, HO(CHOH)₄CH₂COO⁻, C₂H₄(COO)₂²⁻, (CH₂COO)₂²⁻, CH₃CHOHCOO⁻, SiO₃²⁻, SiO₄⁴⁻, Fe(CN)₆³⁻, Fe(CN)₆⁴⁻, BO₃³⁻, PO₃³⁻, or HPO₄²⁻

It is preferred to use hydrotalcites in which (M²⁺) is (Ca²⁺), (Mg²⁺) or a mixture of (Mg²⁺) and (Zn²⁺); (Aⁿ⁻) is CO₃²⁻, BO₃³⁻, PO₃³⁻, x has a value from 0 to 0.5 and y has a value of from 0 to 2. It is also possible to use hydrotalcites which may be described with the formula

[(M²⁺)ₓ(Al³⁺)₂(OH)_{2x+6nz}(Aⁿ⁻)₂yH₂O]

In this formula, (M²⁺) is Mg²⁺ or Zn²⁺, but preferably Mg²⁺. (Aⁿ⁻) is an anion, especially one from the group CO₃²⁻, (OOC—COO)²⁻, OH^{- and S}²⁻, where n describes the valency of the ion.

Y is a positive number, preferably between 0 and 5, very preferably between 0.5 and 5. x and z have positive values, which in the case of x are preferably between 2 and 6 and in the case of z should be smaller than 2. The hydrotalcites of the following formulae are to be regarded as particularly preferred:

Al₂O₃ H 6MgO H CO₂ H 12H₂O,

Mg₄₅Al₂(OH)₁₃ H CO₃ H 3.5H₂O,

4MgO H Al₂O₃ H CO₂ H 9H₂O,

4MgO H Al₂O₃ H CO₂ H 6H₂O,

ZnO H 3MgO H Al₂O₃ H CO₂ H 8-9H₂O,

ZnO H 3MgO H Al₂O₃ H CO₂ H 5-6H₂O,

Mg_{4.5}Al₂(OH)₁₃ H CO₃.

Hydrotalcites are used in the polymer preferably in a concentration of from 0.01 to 5% by weight, particularly from 0.2 to 3% by weight, based on the overall polymer formulation.

8. Thiosynergists, such as dilauryl thiodipropionate or distearyl thiodipropionate, for example.

9. Peroxide-destroying compounds such as, for example, esters of β-thiodipropionic acid, for example the lauryl, stearyl, myristryl or tridecyl ester, mercaptobenzimidazole, the zinc salt of 2-mercaptobenzobenzimidazole, zincalkyldithiocarbamates, zinc dibutyidithiocarbamate, dioctadecyl monosulphide, dioctadecyl disulphide, pentaerythrityl tetrakis(β-dodecylmercapto)propionate.

10. Polyamide stabilizers, such as, for example, copper salts in combination with iodides and/or phosphorus compounds and salts of divalent manganese.

11. Basic costabilizers such as, for example, melamine, polyvinylpyrrolidone, dicyanodiamide, triallyl cyanurate, urea derivatives, hydrazine derivatives, amines, polyamides, polyurethanes, alkali metal and alkaline earth metal salts of higher fatty acids, for example Ca stearate, Zn stearate, Mg behenate, Mg stearate, Na ricinoleate, K palmitate, antimony pyrocatecholate or tin pyrocatecholate, alkali metal and alkaline earth metal salts and also the zinc salt or the aluminium salt of lactic acid.

12. Nucleating agents, such as, for example, inorganic substances, such as, for example, talc, metal oxides, such as, for example, titanium dioxide or magnesium oxide, phosphates, carbonates of sulphates of preferably alkaline earth metals, organic compounds, such as monocarboxylic or polycarboxylic acids and also their salts, such as, for example, 4-tert-butylbenzoic acid, adipic acid; diphenylacetic acid; sodium succinate or sodium benzoate; acetals of aromatic aldehydes and polyfunctional alcohols such as, for example, sorbitol, such as, for example, 1,3-2,4-di(benzylidene)-D-sorbitol, 1,3-2,4-di(4-tolylidene)-D-sorbitol, 1,3-2,4-di(4-ethylbenzylidene)-D-sorbitol, polymeric compounds, such as, for example, ionic copolymers (“ionomers”).

13. Fillers and reinforcing agents, such as, for example, calcium carbonate, silicates, glass fibers, asbestos, talc, kaolin, mica, barium sulphate, metal oxides and hydroxides, carbon black, graphite, wood flour and other flours or fibers of other natural products, synthetic fibers.

14. Other additives, such as, for example, plasticizers, lubricants, emulsifiers, pigments, rheology additives, catalysts, levelling assistants, optical brighteners, flame retardants, antistats, blowing agents.

15. Benzofuranones and indolines, as described, for example, in U.S. Pat. No. 4,325,863, U.S. Pat. No. 4,338,244, U.S. Pat. No. 5,175,312; U.S. Pat. No. 5,216,052; U.S. Pat. No. 5,252,643, DE-A-4316611, DE-A-4316622, DE-A-4316876, EP-A-0589839 or EP-A-0591102, or 3-[4-(2-acetoxyethoxy)phenyl]-5,7-di-tert-butylbenzofuran-2-one, 5,7-di-tert-butyl-3-[4-(2-stearoyloxyethoxy)phenyl]benzofuran-2-one, 3,3′-bis[5,7-di-tert-butyl-3-(4-[2-hydroxyethoxy]phenyl)benzofuran-2-one, 5,7-di-tert-butyl-3-(4-ethoxyphenyl)benzofuran-2-one, 3-(4-acetoxy-3,5-dimethylphenyl)-5,7-di-tert-butylbenzofuran-2-one or 3-(3,5-diethyl-4-pivaloyloxyphenyl)-5,7-di-tert-butylbenzofuran-2-one.

The following examples are intended to illustrate the invention.

### EXAMPLES

### Use Example 1

A cast film of polyacrylonitrile containing 15% by weight of poly[oxy[(2-chloroethoxy)phosphinylidene]ethylidene]; —(2-chloroethyl)— [[(2-chloroethoxy)(2-chloroethyl)-phosphinyl]oxy]-(CAS No. 59036-37-2, Exolit 5087 from Clariant AG), compared with a non-additived film of straight polyacrylonitrile prepared in the same way, exhibits a shortened burning time and burning length in the horizontal burning test.

### Use Example 2

A cast film of polyacrylonitrile containing 15% by weight of 1,3,2-dioxaphosphorinane, 2,2′-[[2,2-bis(chloromethyl)-1,3-propanediyl]bis(oxy)]bis[5,5-dimethyl]-, 2,2′-dioxide (CAS No. 83044-97-7, Exolit 5085 from Clariant AG), compared with a non-additived film of straight polyacrylonitrile prepared in the same way, exhibits a shortened burning time and burning length in the horizontal burning test.

1. Use of phosphorus compounds of the formulae (I) or (II) 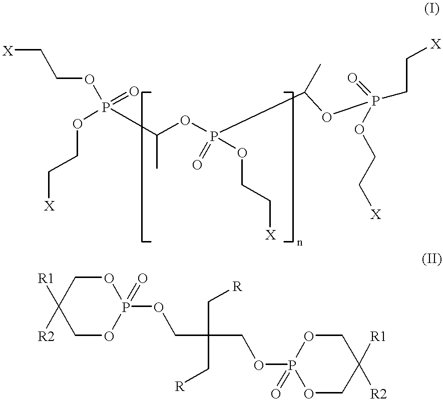
where
X is chloro or bromo,
R₁ and R₂ independently of one another are hydrogen, C₁₋₁₈ alkyl, C₆₋₁₈ aryl, C₇₋₂₄ alkylaryl, or R₁ and R₂ together form a cyclohexyl or cyclohexenyl radical, and
R is chloro, bromo or a group of the formula (III) 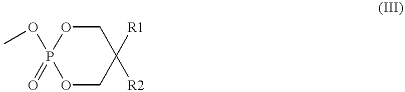
and
n is a number between 0 and 20,
as flame retardants for polyacrylonitrile, its copolymers or polymer blends thereof, especially fibers or films of these materials.

2. Use according to claim 1, wherein
X is chloro,
R₁ and R₂ independently of one another are hydrogen, C₁₋₁₂-alkyl, phenyl or benzyl, or R₁ and R₂ together form a cyclohexyl radical, and
R is chloro or a group of the formula (III), and
n is a number between 0 and 10.

3. Use according to claim 1, wherein
X is chloro,
R is chloro or a group of the formula (III),
R₁ and R₂ are C₁₋₆ alkyl or together are a cyclohexyl radical, and
n is a number from 0 to 10.

4. Use according to claim 1, wherein
X is chloro,
R is chloro,
R₁ and R₂ are methyl, and
n is a number from 0 to 5.

5. The use according to claim 1, characterized in that 5-20% by weight, based on the polymer to be stabilized, are used.

6. Flame retarded fibers or films of polyacrylonitrile, its copolymers or polymer blends thereof, containing 5-20% by weight, based on the polymer, of compounds of the formula (I) or (II) according to claim 1.
